(19) United States
(12) Patent Application Publication
(10) Pub. No.: US 2015/0023126 A1
(43) Pub. Date: Jan. 22, 2015

(54) SMART MIXER HAVING AUTOMATIC DISPENSING AND MIXING FEATURES

(71) Applicants: Vanessa Brown, Fort Lauderdale, FL (US); Brittanni M. Wright, Fort Lauderdale, FL (US)

(72) Inventors: Vanessa Brown, Fort Lauderdale, FL (US); Brittanni M. Wright, Fort Lauderdale, FL (US)

(21) Appl. No.: 14/333,870

(22) Filed: Jul. 17, 2014

Related U.S. Application Data
(60) Provisional application No. 61/847,637, filed on Jul. 18, 2013.

(51) Int. Cl. A47J 43/07; A47J 43/044

(52) U.S. Cl. CPC A47J 43/07; A47J 43/044; A47J 2043/04454
USPC 366/142; 366/150.1; 366/177.1

(57) ABSTRACT

A smart mixer appliance includes a set of ingredient trays. The appliance includes a nozzle-based food distribution assembly to transfer ingredients from the trays into a container. A motor system drives a set of mixer beaters to mix the container contents. A user accesses a network resource and selects a recipe having instructions for ingredient provisioning and mixing. The ingredient trays are loaded with the recipe ingredients. The recipe instructions are converted into a control procedure suitable to automatically control the ingredient transfer and mixing operations. A controller implements the recipe instructions by managing the operation of the food distribution system and motor system according to the control procedure.

### CROSS-REFERENCE TO RELATED APPLICATIONS

This application claims priority to U.S. Provisional Application No. 61/847,637 filed on Jul. 18, 2013 which is herein incorporated by reference in its entirety.

### FIELD OF THE INVENTION

The present invention relates to a food processing appliance and method of use, and more particularly, a smart mixer to automatically dispense ingredients into a mixing container from a variety of ingredient receptacles and automatically mix them.

### BACKGROUND OF THE INVENTION

Food preparation typically involves following a recipe having instructions for placing a variety of ingredients into a container and then mixing the container contents. These are manual tasks performed by the food preparer. A measured amount of each ingredient is retrieved from its normal storage facility and then manually placed by the food preparer into the container. This process of manually pouring ingredients into the container continues until all of the ingredients have been added.

Once the ingredients are combined, the food preparer manually stirs and mixes the aggregation. Even if a mixing appliance is used such as a set of motorized beaters, the food preparer still must manually handle, operate, and maneuver the beaters. Difficulties arise from user fatigue, imprecise and non-uniform maneuvering of the beaters resulting in inadequate mixing, and the need to have significant time to retrieve, measure, and pour out the ingredients.

This conventional food preparation approach is labor intensive and inefficient. There are numerous manual tasks for the food preparer to perform, making the food preparation susceptible to errors and mistakes. The food preparer must also expend concentrated and detailed effort in following the recipe instructions, while at the same time needing to alternate between reading the instructions and performing the specified tasks. This activity can become a meticulous and laborious process.

Accordingly, there remains a need in the art to relieve the food preparer of the labor and time intensive manual tasks associated with ingredient loading and mixing, and replace these manually-oriented activities with a more automated approach.

### SUMMARY OF THE INVENTION

The present invention overcomes the deficiencies of the known art and the problems that remain unsolved by providing a method and respective apparatus for automatically performing a procedure to selectively transfer ingredients into a container from a set of ingredient receptacles and then mixing the container contents.

In accordance with one embodiment of the present invention, the invention includes a food processing system for use with a container, said system comprising:
a plurality of ingredient receptacles;
a dispenser facility configured to controllably transfer ingredients from at least one of the ingredient receptacles into the container;
a mixing facility configured to controllably mix ingredient contents within the container;
a processor configured to generate a control procedure representative of received recipe instructions; and
a controller configured to control the operation of the dispenser facility and the mixing facility according to the control procedure.

In one aspect, the system includes a network connection configured to provide a user with access to at least one resource including at least one recipe.

Introducing another embodiment, there is provided a method of use in association with a food processing appliance including a plurality of ingredient receptacles, a dispenser facility, and a mixing facility, the method includes steps of:

a user selecting a recipe having instructions;

the appliance formulating a control procedure representative of the recipe instructions;

the appliance dispensing ingredients into the container according to the control procedure; and

the appliance mixing ingredient contents in the container according to the control procedure.

In another aspect, the method further comprises a step of the user accessing at least one network resource including at least one recipe.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, in which:

FIG. 1 presents an isometric view of an exemplary smart mixer as fully assembled;

FIG. 2 presents a partially exploded isometric view of the smart mixer originally introduced in FIG. 1;

FIG. 3 presents a rear isometric view of the smart mixer originally introduced in FIG. 1;

FIG. 4 presents a front elevation view of the smart mixer originally introduced in FIG. 1;

FIG. 5 presents a bottom isometric view of the smart mixer originally introduced in FIG. 1;

FIG. 6 presents an exploded isometric view of an exemplary ingredients tray and associated sifter, for use in the smart mixer illustrated by FIGS. 1-5;

FIG. 7 presents an isometric view of the assembled ingredients tray and sifter as previously presented in FIG. 6;

FIG. 8 presents a front elevation view showing interior components of the smart mixer as previously presented in FIGS. 1-7;

FIG. 9 presents a block diagram schematic illustration of the smart mixer as previously presented in FIGS. 1-8;

FIG. 10 presents a flowchart illustrating a procedure to execute the dispensing and mixing operations specified by a user selected recipe, using the smart mixer as previously presented in FIGS. 1-9; and

FIG. 11 is a flowchart illustrating an alternate procedure to execute the dispensing and mixing operations specified by a user selected recipe, using the smart mixer as previously presented in FIGS. 1-9.

Like reference numerals refer to like parts throughout the several views of the drawings.

### DETAILED DESCRIPTION

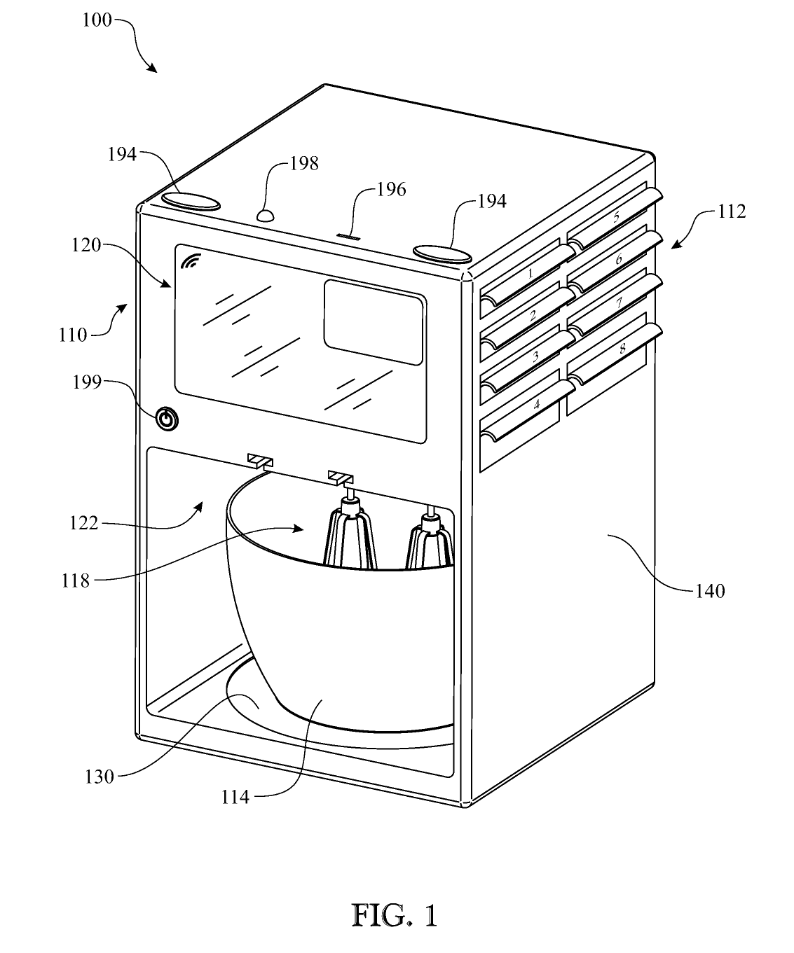

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

A smart mixer assembly 100 is presented in various configurations in the illustrations of FIGS. 1 through 5 and 8. The smart mixer assembly 100 includes a cabinet console 112 that houses the various components to facilitate the dispensing and mixing of ingredients in a mixing receptacle. The smart mixer assembly 100 has utility as a food processing appliance enabling a user to automatically prepare food for further processing, e.g., cooking. A set of ingredient trays 112 supplies a variety of ingredients to a nozzle assembly 116 that dispenses the ingredients into a mixer bowl 114. In the mixer bowl 114, the ingredient mixture is processed by a set of mixer beaters 118. The process of dispensing the ingredients into mixer bowl 114, and then subsequently processing the dispensed mixture, is performed automatically. A computer system 190 facilitates programmable control of the dispensing operation, via control of the nozzle assembly 116, and programmable control of the mixing operation, via control of the mixer beaters 118. In an enhanced configuration, the computer system 190 has a facility to access host resources, such as Internet servers, that permit the user to access and retrieve recipes. These recipes serve to define the control operation performed by the computer system 190.

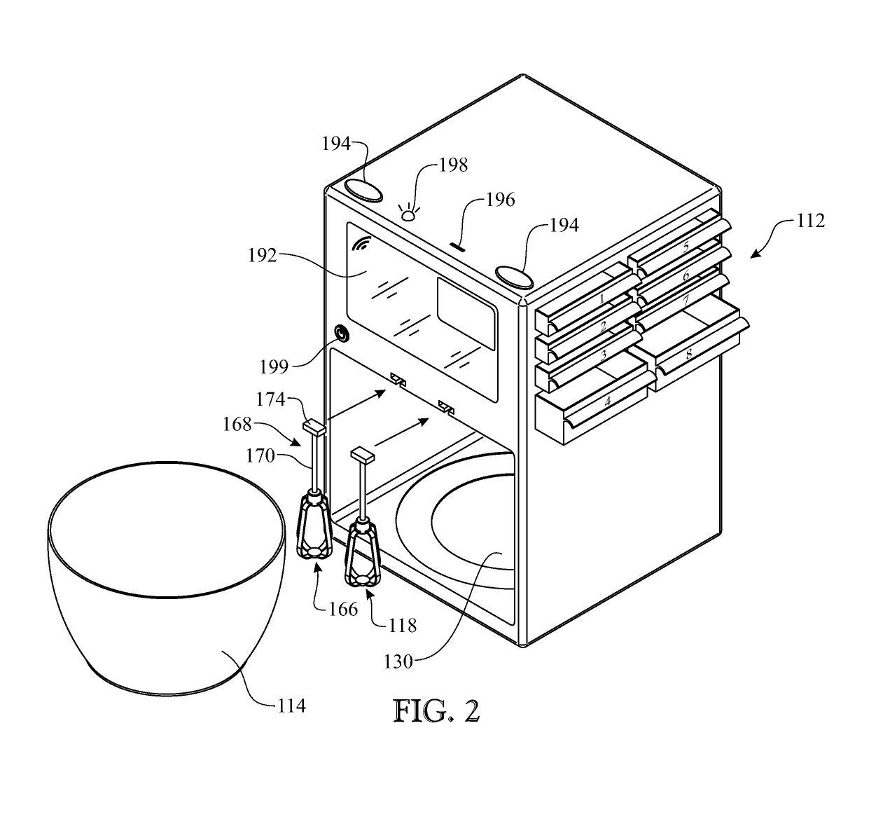

The cabinet 112 has a generally upright orientation in the form of a rectangular prism, such as a box-type enclosure or console that is partitioned into an upper section 120 and an adjacent lower section 122. The lower section 122 defines a compartment space of sufficient size and dimensions to accommodate a mixer bowl 114 in a position suitable to receive ingredients dispensed into it from components in upper section 120, namely, the combination of ingredient trays 112 and nozzle assembly 116. The lower section 122 is fitted or adapted to house a rotatable turntable platform 130 upon which the mixer bowl 114 is stationed during use, as shown in FIG. 1. The turntable platform 130 defines a surface where the mixer bowl 114 is placed, as best seen in FIG. 2. The turntable platform 130 facilitates rotation or turning of the mixer bowl 114 while the mixer beaters 118 are in usage, which enhances the mixing of the dispensed ingredients.

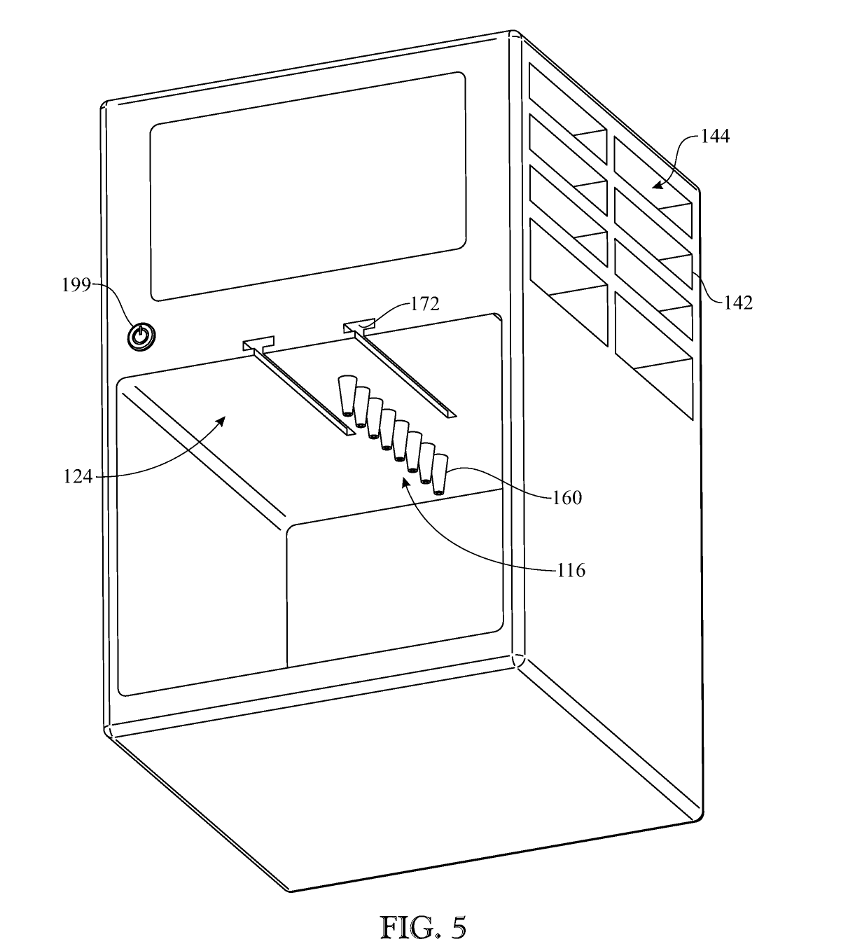

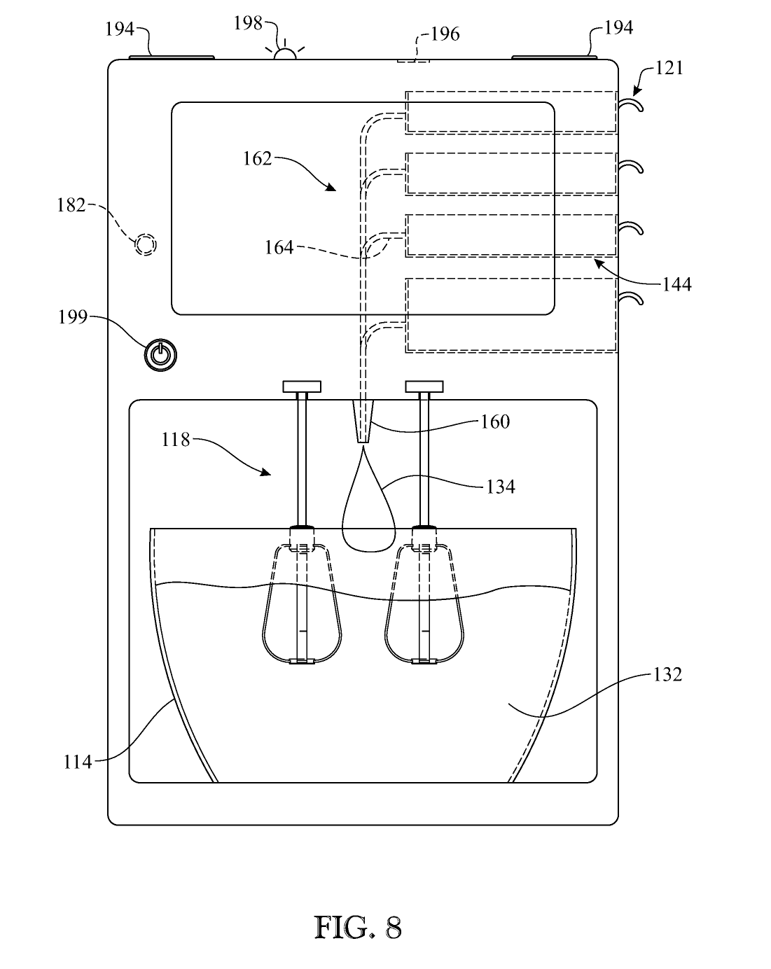

The cabinet 112 includes a rearward side or wall defined by a panel 140, as shown in FIGS. 1 through 3. The panel 140 includes a set of apertures or openings 142 located at its upper end, as shown in FIG. 5. These apertures 142 serve as the proximal ends of a set of spaced-apart, tray-receiving slots 144 that extend into the upper section 120 of cabinet 112, as shown in FIG. 8. Each slot 144 defines a compartment space to individually receive, support, and house a corresponding ingredient tray 112. For illustrative purposes, the set of slots 144 is arranged in two columns of four slots each, where each column has an upper series of three slots of uniform size and a bottom slot of larger size. Any suitable arrangement of tray-receiving slots 144 can be used.

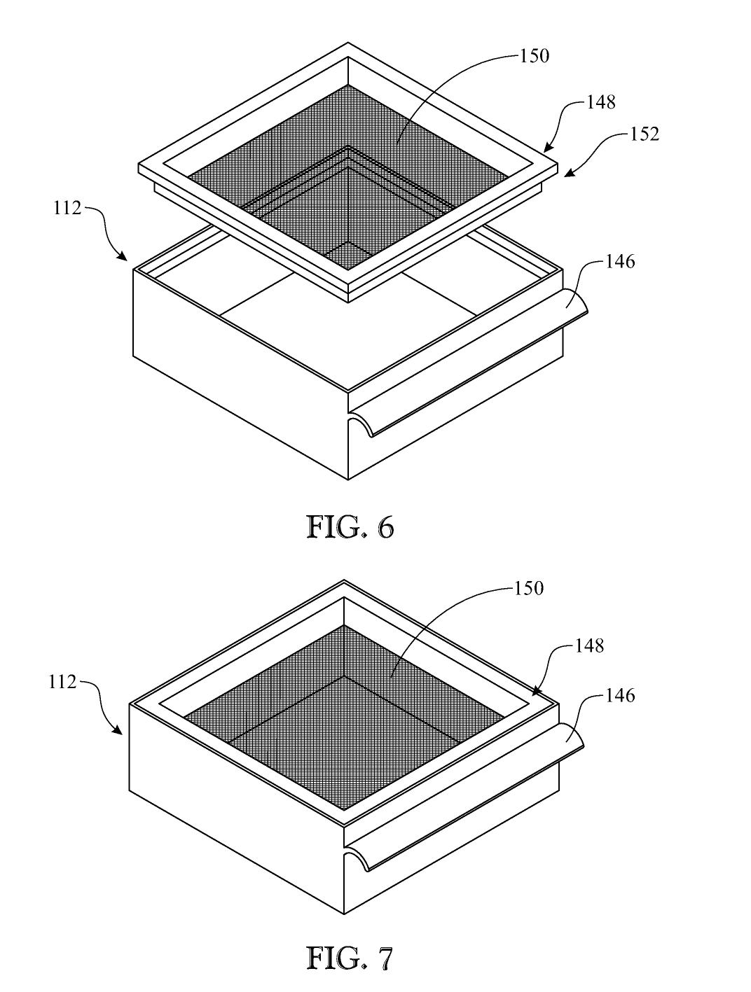

The ingredient trays 112 are provided in one illustrative form as a drawer-type configuration having an open upper end to facilitate the placement and loading of ingredients, as shown in FIG. 6. The trays 112 may be sized and configured in any form suitable to store ingredients prior to dispensing. The trays 112 can be designed according to various sizes and shapes, depending upon the structure of the slot 144 to which an individual tray 112 is assigned. For illustrative purposes, the smart mixer 100 includes a set of eight trays divided into a first subset of six trays of uniform size and a second subset of two trays of uniform size larger than the trays of the first subset. Each tray 112 preferably includes a handle 146 or other such similar feature to facilitate ease of placement and removal of tray 112 in its respective slot 144.

All or some of the trays 112 can be equipped with a sifter 148 as the need arises, as best seen in FIGS. 6 and 7. The sifter 148 is configured with a mesh, screen, or other type of filter structure 150 to promote sifting and disaggregation of the ingredients as they are poured into the ingredient tray 112. An upper end of sifter 148 has a peripheral edge with a projecting rim 152 that sits on a corresponding surface formed at the upper end of the tray 112. In this manner, the sifter 148 is easily located and secured in resting arrangement on the tray 112. The sifter 148 has a recessed configuration so that when sifter 148 is located on tray 112, the sifter 148 becomes nested within an interior space of the tray 112, preventing the need for any additional space to accommodate the sifter 148 other than the space of the slot 144 needed to receive tray 112.

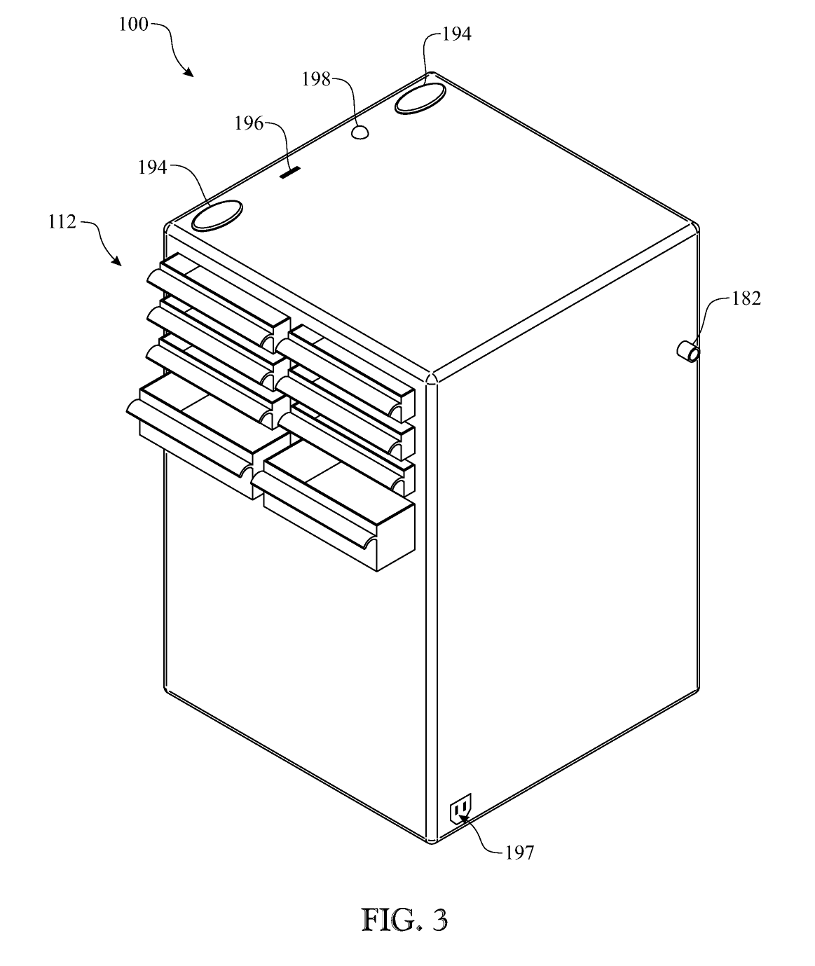

The ingredients trays 112 are disposed in sliding relationship within slots 144. For this purpose, each slot 144 may include any suitable mechanism for aligning and guiding the placement and movement of ingredient tray 112 within its respective slot 144. Each tray 112 can be completely removable. The partial removal of ingredient trays 112 from their respective slots 144 is illustratively depicted in FIG. 3. In use, each ingredient tray 112 receives and stores a supply of ingredients placed within the tray 112. The ingredient trays 112 can be furnished with an external marking, such as a numbering scheme, in order to notify a user of a pre-programmed dispersing order 221 of the ingredients according to the numbering scheme, as shown in FIGS. 2 and 3.

The nozzle assembly 116 for dispensing ingredients into the mixer bowl 114 includes a set of individual controllable nozzles 160, as shown in FIGS. 5 and 8. A coupling assembly 162 connects the nozzle assembly 116 to the ingredient trays 112, as shown in FIG. 8. The coupling assembly 162 includes a set of tubes 164 each connecting a respective ingredient tray 112 to a corresponding dedicated nozzle 160.

The individual nozzles 160 of the nozzle assembly 116 are collectively disposed in a generally vertical, downward facing orientation suitable to dispense ingredients into the mixing bowl 114. The nozzles 160 are mounted to a generally planar ceiling 124 defining an upper end of the cabinet lower section 122. In one form, the nozzles 160 can be positioned in a linear arrangement extending along a front to back direction. The nozzles 160 are located so that the projectile pathway or spray zone from each nozzle 160 is aligned with the interior of the mixing bowl 114 when it is situated in its operational position on the turntable 130. The nozzles 160 are preferably removable for cleaning purposes. The nozzles 160 can be selected with different performance characteristics in mind, such as dispenser flow rate, dispersal radius, and granularity of emissions.

The coupling assembly 162 for connecting the ingredient trays 112 to the nozzle assembly 116 is located within the cabinet upper section 120. The tubes 164 of the coupling assembly 162 define a network of pathways for communicating ingredients from the ingredient trays 112 to the nozzles 160 of nozzle assembly 116. The tubes 164 may be provided in a variety of suitable forms, such as rigid piping or flexible hoses. Each tube 164 has a proximal end defining an entry point for receiving ingredients from a respective ingredient tray 112, and a distal end defining an exit point for supplying ingredients to a respective nozzle 160.

In order to provide the tube 164 with access to the interior of its respective ingredient tray 112, and so facilitate the transfer of ingredients into tube 164 at its proximal end, a mating mechanism using male and female fittings can be used to connect the tube 164 to the ingredient tray 112. For this purpose, the rearward end of the ingredient tray 112 is fitted with a first fitting member that defines an access means into the interior of the tray 112 from an external point. The tube 164 dedicated to this tray 112 is fitted at its proximal end with a second fitting member that is matably compatible and complementary with the first fitting member attached to the tray 112. During assembly, the tube 164 is attached to its respective ingredient tray 112 by interconnecting the first fitting member of tray 112 with the complementary second fitting member of tube 164 in locking mated engagement. This attachment permits ingredients from the ingredient tray 112 to be drawn into its respective tube 164.

The tube 164 can be connected to its respective nozzle 160 by any suitable means known to those skilled in the art. In one form, the tube 164 can be provided at its distal end with a fitting that mates with a complementary fitting on the nozzle 160. It is preferable to configure the fitting mechanisms with quick-connect and quick-release features in order to facilitate ease of attaching the ends of tubes 164 to the nozzles 160 and ingredient trays 112. While the illustrated implementation of the coupling assembly 160 is a set of tubes 164, any means known to those skilled in the art can be used to transfer ingredients from the ingredient trays 112 to the nozzle assembly 116. For example, any means of communicating material substances (i.e., ingredients) can be employed to direct ingredients from the ingredient trays 112 to the nozzles 160.

The smart mixer assembly 100 is equipped, in one form, with a set of two mixer beaters 118, although any suitable number of mixer beaters 118 can be used. The beaters 118 are removably mounted to the ceiling 124 of the cabinet lower section 122. The beaters 118 are oriented in a generally vertical orientation extending downwardly from the ceiling 124. The beater 118 has a working end 166 and a mounting end 168 connected together with a stem 170, as shown in FIG. 2. The working end 166 is equipped with a conventional design of mixing blades.

The mixer beaters 118 are mounted in a configuration that permits independent movement of the beaters 118 into different mixing locations. In one illustrative form, in order to locate and situate the mixer beaters 118 into an operating position above the mixer bowl 114, a set of grooves or channels 172 are formed in the ceiling 124 of the cabinet lower section 122, as shown in FIG. 5. Each groove 172 defines a track along which a respective mixer beater 118 can be located and then selectively maneuvered into a desired position above the mixer bowl 114.

The interfit of the mixer beater 118 to groove 172 uses a tongue-and-groove design. The groove 172 extends lengthwise in a generally front-to-back direction of the cabinet 110. The groove 172 has a generally T-shaped cross-section having a cross-wise feature and an orthogonal axial feature, both defining female spaces to receive corresponding male members belonging to the handle section of mixer beater 118. In particular, the mixer beater 118 is fitted at its mounting end 168 with a male piece 174 attached to a free end of the stem 170. The male piece 174 is provided in a form having a complementary mating fit with the female cross-wise track of the groove 172.

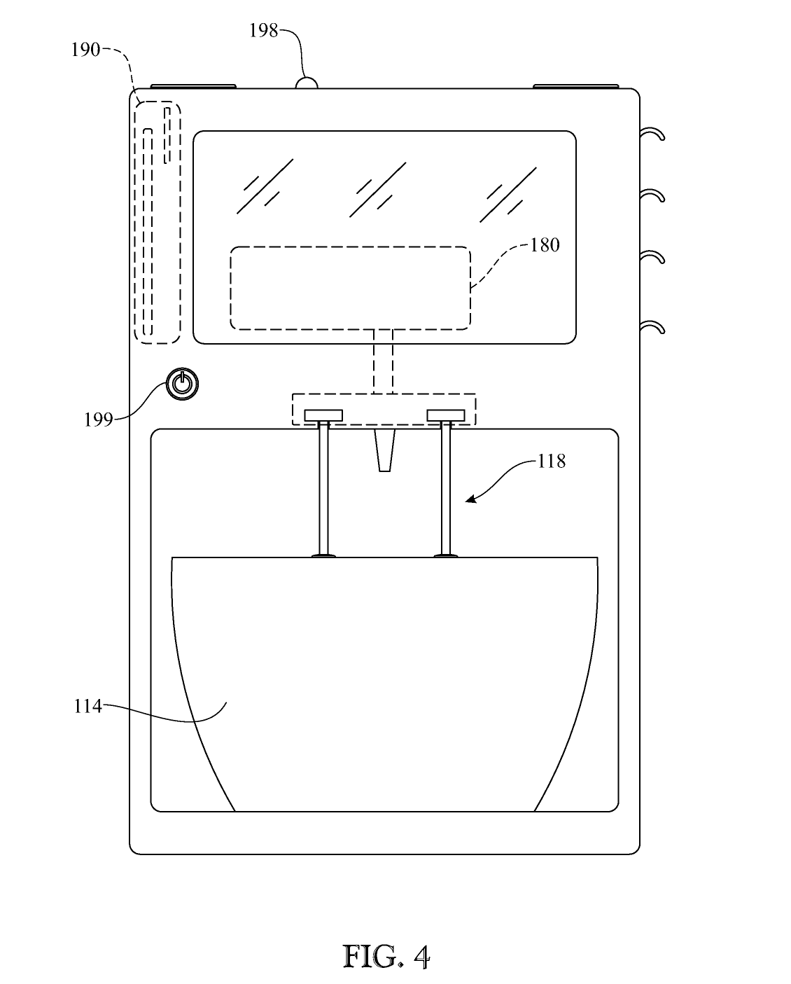

During assembly, the mixer beater 118 is installed by placing it in sliding engagement within the groove 172. In particular, the male piece 174 of the mixer beater 118 is inserted into the female space defined by the cross-wise feature of the groove 172, while simultaneously the stem 170 of the mixer beater 118 is situated within the axial feature of groove 172, as shown in FIGS. 4 and 8. As so positioned, the mixer beater 118 can then be maneuvered into position by sliding it along groove 172. The integration of the mixer beaters 118 into the smart mixer assembly 100 is performed with a view towards ensuring that the working end 166 of the mixer beater 118 reaches an adequate depth within the mixer bowl 114 to facilitate proper mixing, as shown in FIG. 8.

The smart mixer assembly 100 includes a motor system 180 to drive the mixer beaters 118 during operation, as illustrated in FIG. 4. The motor system 180 is housed within the upper section 120 of the cabinet 110. The motor system 180 can be implemented using any suitable means known to those skilled in the art that is effective in transmitting a rotary driving motion to mixer beaters 118.

The smart mixer assembly 100 also includes a water port 182, as illustrated in FIG. 3. The water port 182 is adapted for connection to a water line or other water source, in order to facilitate the direct routing of water into the mixer bowl 114 instead of via the ingredient tray 112. In particular, the availability of the water port 182 avoids the need to allocate one of the ingredient trays 112 to the storage of water. Various configurations can be used to transmit water entering via the water port 182 to the mixer bowl 114. In one form, the water port 182 can be coupled to one of the nozzles 160 of the nozzle assembly 116, enabling the operation of the nozzle assembly 116 to admit water into the mixer bowl 114. Alternately, a separate dedicated supply line can be used to communicate water from the water port 182 to the mixer bowl 114. For this purpose, a conventional plumbing apparatus or fluid flow mechanism such as a valve assembly can be used to controllably admit water into the mixing bowl 114 from this supply line.

The smart mixer assembly 100 includes various components to enable the user to interact with the appliance in a manner facilitating user-directed control of the ingredient dispensing and mixing operations. In a preferred form, the smart mixer assembly 100 includes a networked computer system 190, as shown in FIG. 4. The computer system 190 can be implemented in the form of a computer tablet or circuit board and processor system, which allows the user to direct the operation of the nozzle assembly 116 and the motor system 180 for the mixer beaters 118. Additionally, the smart mixer assembly 100 includes features that promote a user-friendly experience, such as an interactive feature that gives the user the ability to review recipes and select one of them for preparation using the smart mixer assembly 100. In a preferred form, the smart mixer assembly 100 includes an audio-visual system, such as a display screen 192 and a set of speakers 194, which enables the user to view how a selected recipe is followed during a food preparation demonstration. The audio-visual system is illustrated in FIGS. 2, 3, and 8.

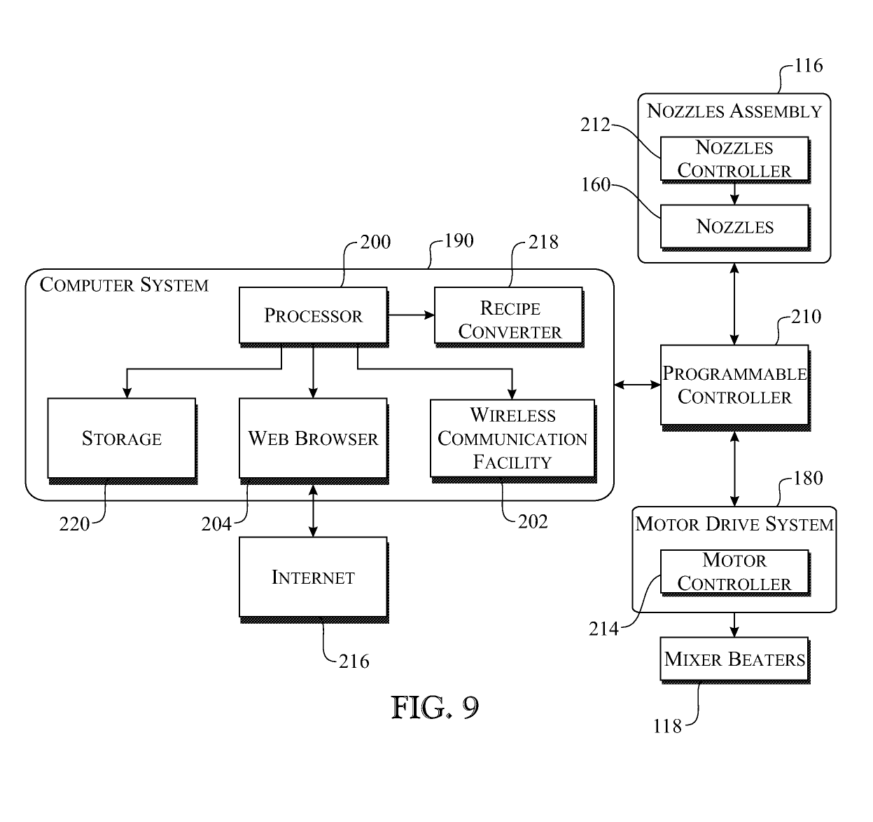

The computer system 190 includes a processor 200, a wireless communications facility 202, and a browser 204, as shown in FIG. 9. The computer system 190 is integrated with a programmable controller 210 that is adapted to manage the operation of the nozzle assembly 116 and the operation of the mixer beaters 118 (via the motor system 180), as shown in FIG. 9. The computer system 190 supplies control instructions to the programmable controller 200, which in turn manages the operation of the nozzle assembly 116 and the motor system 180 in accordance with the control instructions.

The nozzle assembly 116 includes a controller 212 configured to selectively activate the individual nozzles 160 in response to control instructions received from the programmable controller 210. A wide range of control operations is available to activate and regulate the dispensing activity of the nozzles 160. The control parameters for directing the dispensing activity of the nozzles 160 can include but is not limited to: the order or sequence of firing or activating the individual nozzles; the duration of nozzle activation; the flow rate of dispensing; and the ability to cycle through the nozzle activation process in repeated fashion. Any mode of nozzle activation is possible. For example, the nozzles 160 can be activated in a sequential, serial manner according to a prescribed firing order. Alternately, different combinations of nozzles 160 can be fired in parallel, e.g., at the same or overlapping interval. The nozzles 160 can also be activated repeatedly. The procedure or routine for activating the nozzles 160 is formulated based on the specifications and requirements of the recipe that is being followed or in accordance with a pre-programmed order 221 stored within the computer system 190.

This dynamic range of nozzle regulation affords the user versatility in food preparation because it gives the user the flexibility to choose recipes that have a variety of options for how ingredients are dispensed and loaded for mixing. For example, the programmable control of the nozzles 160 permits ingredients to be loaded in a metered or regulated manner, rather than in a single loading process that completely empties the ingredient tray 112 all at once. This metering process can proceed in a progressive manner, in which gradually increasing (or simply different) amounts of an ingredient can be added at different points in the procedure. This has advantages for mixing ingredients that can be difficult to aggregate with other ingredients. Additionally, the programmable control of the nozzles 160 also permits ingredients to be added in any order, and in varying amounts, which has advantages when it is desired to mix certain ingredients before adding others.

An additional benefit to selective control of the nozzle-based dispensers is that the user need not be so precise in ensuring that each ingredient tray includes the exact amount of ingredients called for in the recipe. For example, it may be sufficient for the user simply to ensure that an oversupply of ingredients is loaded into an ingredient tray, which is easier than a providing a precise amount. In this manner, the user can quickly load a quantity of ingredients into the trays. The nozzles can then be controlled in a manner that selectively meters out the ingredients in the precise amounts required by the recipe. In this way, the accurate measuring out of ingredients is shifted from the food preparer to the automatically controlled nozzle dispensers.

The motor system 180, which drives the mixer beaters 118, includes a controller 214 configured to selectively control the operation of the motor system 180, and hence the mixing activity of the driven mixer beaters 118, in response to control instructions received from the programmable controller 210. The programmable control of the motor system 180 can manage operating parameters including but not limited to: the activation and de-activation of the motor system 180 (and hence the on/off characteristics of the mixer beaters 118); the duration of mixing; and the speed of rotation of the mixer beaters 118, hence controlling the intensity of the mixing activity.

In a preferred form, the management of the dispensing and mixing operations can be conducted in an integrated, coordinated approach featuring the ability to alternate periods of dispensing and mixing or even conduct both operations at the same or overlapping time. Compared to a process where the mixing operation is performed only upon completion of the dispensing operation, this coordinated parallel management of the dispensing and mixing tasks gives the user flexibility to choose recipes involving a more complex set of instructions that require interleaving of the dispensing activity with intervals of mixing.

The smart mixer assembly 100 is provided with user interactive features enabling the user to direct the operation of the nozzle assembly 116 and motor system 180 according to a chosen recipe, thus giving the user selective command over the ingredient dispensing process and the mixing operation. In particular, the combination of the browser 204 and wireless facility 202 permits the user to access a network of host resources, such as servers on the Internet 216. From these Internet resources, the user can select and download a recipe that is furnished to the processor 200. The processor 200 includes a recipe converter 218 that functions as a conversion facility to encode, convert and otherwise translate the chosen recipe into a command and control format that can be used by the programmable controller 210 to govern the operation of nozzle assembly 116 and motor system 180 via their respective controllers 212 and 214. The commands issued by the recipe converter 218 represent a procedure for dispensing and mixing that executes and otherwise implements the set of instructions constituted by the chosen recipe.

A set of instructions for a pre-programmed dispensing order 221 can be stored in storage 220 on the computer system 190. The pre-programmed dispensing order 221 can be associated with the numbering scheme represented by the external markings on the ingredient trays 112. In an exemplary embodiment, the instructions for the pre-programmed dispensing order 221 may command the nozzle assembly 116 to dispense the ingredients in the ingredient trays 112 in the particular order specified by the pre-programmed dispensing order 221, as will be explained below. The computer system 190 can store a multitude of pre-programmed control instructions of varying dispensing orders, nozzle activation duration, dispensing flow rate, and the like, wherein the user may select the desired pre-programmed control instructions via a user-input interface, such as a display screen 192 with touch screen capability.

The display screen 192 supports the user interactive features available in the smart mixer assembly 100. The display screen 192 can be used by the user to perform a variety of tasks: (i) navigate through existing recipes stored within the environment of the smart mixer assembly 100, such as a storage device 220; (ii) surf the Internet 216 for recipes via the combination of web browser 204 and wireless facility 202; and (iii) watch instructional videos of recipe making, made available either as downloaded files or locally resident files. The display screen 192 can be the display element of a computer tablet (e.g., iPad) that is integrated as a distinct stand-alone device into the console housing of the smart mixer assembly 100. Alternately, the display screen 192 can be integrated into the computer system 190.

A universal serial bus (USB) port 196 is provided in a readily accessible location, such as the topside of the cabinet 110, as shown in FIGS. 1 through 3 and 8. The USB port 196 facilitates a connection with peripheral devices, such as flash drives, iPads, iPods, and other devices that store multimedia files, e.g., music, videos or recipes. The USB port 196 can be connected to the computer system 190 and/or display screen 192 in order to permit these facilities to access the peripheral devices made available by the USB port 196.

The computer system 190 and/or tablet-based display screen 192 are configured for connection to a resource network, such as the Internet 216 or a home LAN network. This Wi-Fi capability can be implemented with a wireless card installed on the computer system 190 (the wireless communications facility 202) or the tablet-based display screen 192. The availability of Wi-Fi at the smart mixer assembly 100 is indicated by a Wi-Fi notification light 198 that is situated in a location readily seen by the user, such as the topside of the cabinet 110, as shown in FIGS. 1 through 4 and 8. The computer system 190 can also be equipped with a radio transmitter-receiver in order to access the resources of a local content source, such as the home LAN network.

The speakers 194 are located on the topside of the cabinet 110 in order to promote ease of listening, as shown in FIGS. 1 through 3 and 8. The speakers 194 are integrated with the apparatus that is configured to playback audio-visual material. For example, the speakers 194 may be connected to the computer system 190 and/or the tablet-based display screen 192.

The smart mixer assembly 100 receives power via a plug 197 placed in a readily accessible location, as shown in FIG. 3. The smart mixer assembly 100 is equipped with an on/off switch, such as a manually depressible button 199, as shown in FIGS. 1-2, 4-5, and 8.

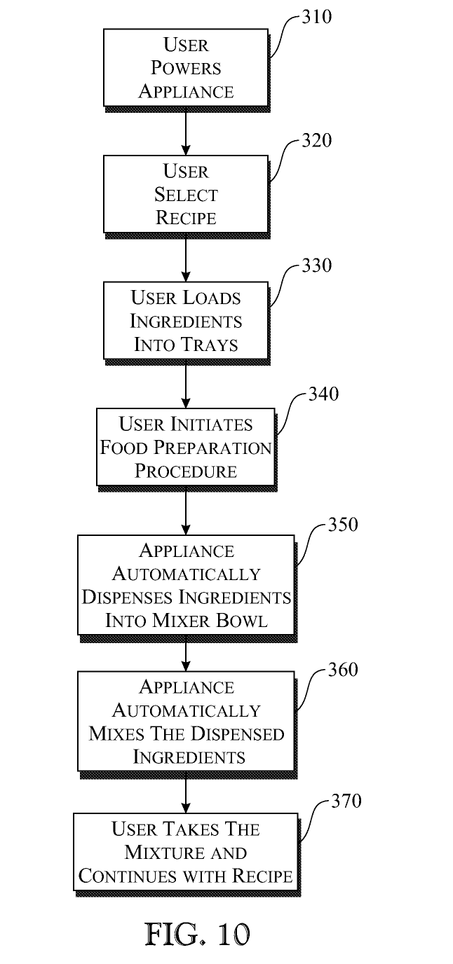

During operation of the smart mixer assembly 100, a procedure is executed to govern the dispensing and mixing activities, as illustrated in the flowchart of FIG. 10 in conjunction with FIG. 9. The user powers on the appliance via the on/off switch 199 in block 310. The user selects a recipe, which is displayed on the screen 192 in block 320. The recipe can be chosen from a library of recipes stored on storage 220, or retrieved from the Internet 216 via the web browser 204 and the Wi-Fi connection provided by wireless facility 202. Based on the displayed instructions of the selected recipe, the user adds the appropriate measured amounts of ingredients to the ingredient trays 112 in block 330. In one aspect, where the ingredient trays 112 are numbered in a manner indicating the order of dispensing, the user adds the correct ingredients into each tray 112 depending upon the sequence of ingredient loading specified by the recipe. The user then initiates the dispensing operation, such as by selecting a start button on the display touchscreen 192 in block 340.

At this point, the loading of the ingredients from the various ingredients trays 112 into the mixer bowl 114 commences automatically in block 350. The smart mixer assembly 100 automatically starts to add the ingredients into the mixer bowl 114 in the sequential order indicated by the labeling of the ingredients trays 112. In particular, the individual nozzles 160 of the nozzle assembly 116 are automatically activated in the proper sequence in order to dispense the ingredients in a manner reflecting the numbered ordering of the ingredient trays 112. For example, the ingredients in the tray labeled with a “1” will be dispensed first; next, the ingredients in the tray labeled with a “2” will be dispensed next; and this process continues until ingredients from all of the trays have been transferred and loaded into the trays 112. Referring to FIG. 8, an illustrative ingredient emission 134 is shown issuing from nozzle 160 during the dispensing operation, leading to the build-up of ingredient contents 132 in mixer bowl 114.

The mixer beaters 118 will engage after each of the ingredients have been transferred into the mixer bowl 114. In particular, upon completion of the activation of each nozzle 160, indicating termination of the dispensing operation of each corresponding ingredient, which may be sensed by a sensor, the motor system 180 is activated, thereby driving the mixer beaters 118 and causing the mixing activity to occur. After the mixing operation is finished, the user removes the mixer bowl 114 and continues with the food preparation task in block 370, such as placing the mixture into a pan or container for further processing.

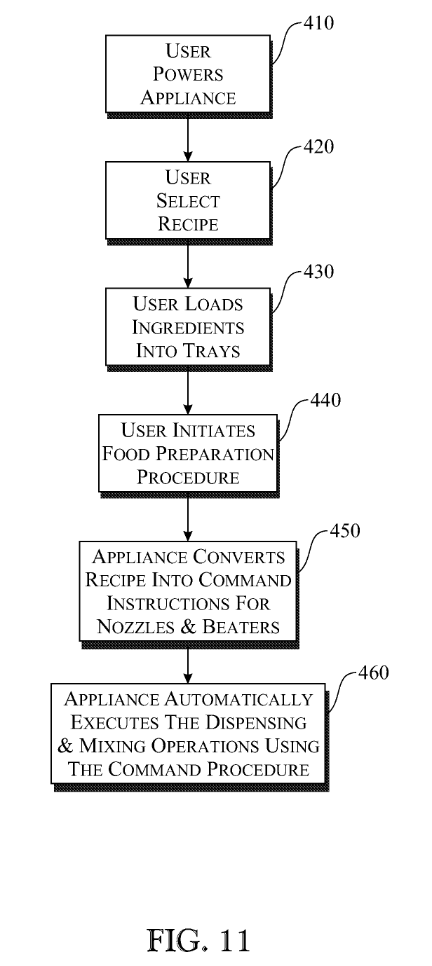

According to another aspect, an alternate procedure can be implemented to govern the dispensing and mixing activities, as illustrated in the flowchart of FIG. 11 in conjunction with FIG. 9. As before with the procedure illustrated in FIG. 10, the user powers the appliance in block 410, selects a recipe in block 420, and loads the appropriate amount of ingredients into the trays in block 430. Based on the recipe instructions, the recipe converter 218 formulates a nozzle firing procedure by converting the dispenser-related recipe instructions into a representative command construct that defines a control operation to manage the dispensing operation in block 450. The nozzle firing procedure can specify the control of various parameters, such as the sequence and duration of the nozzle activation. The recipe converter 218 also formulates a motor activation procedure by converting the mixing-related recipe instructions into a representative command construct that defines a control operation to manage the mixing operation. The motor activation procedure can specify the control of various parameters, such as the speed and duration for running the mixer beaters 118. These procedures fulfill, represent, and otherwise embody the recipe instructions. The procedures, in the form of command constructs, are forwarded to a programmable controller 210, which manages the operation of the nozzle assembly 116 and motor drive system 180 according to the received commands. This manner of converting the recipe instructions into a corresponding command structure and managing the dispensing and mixing operations according to the command structure is performed automatically. Upon receiving the commands generated by the command structure, the nozzle assembly 116 and motor drive system 180 automatically executes the dispensing and mixing operations accordingly in block 460.

The smart mixer assembly 100 provides several advantages over the current art. The automatic dispensing of ingredients into the mixer container relieves the user of the formerly labor-intensive task of retrieving each ingredient and individually loading the correct measured amount of each ingredient into the container. Additionally, the automatic mixing of the container contents promotes a more uniform mixing and provides a mixture ready for further processing. Further, whereas in the art the food preparer must follow in a detailed way the reading of the instructions, while alternately pausing to carry out the required food preparation tasks, the smart mixer assembly 100 enables the user to select a recipe and then leave the balance of the food preparation tasks to the management facilities of the appliance. In particular, the recipe instructions are converted into an automatic procedure for performing the dispensing and mixing operations. The user is only required to perform the preliminary task of loading the ingredient receptacles with the proper ingredients.

The smart mixer assembly 100 automatically adds the measured amount of ingredients into the mixer bowl in a predetermined order and mixes the ingredients. Several features distinguish the smart mixer assembly 100. The assembly includes multiple ingredient compartments built into the appliance console, facilitating the automatic selection and dispensing of a variety of ingredients. The user is able to access the Internet via the smart mixer appliance, enabling the user to select and download a desired recipe that the appliance can convert into a command procedure useful in automatically controlling the dispensing and mixing operations in fulfillment of the recipe instructions. The appliance is equipped with a processor and programmable controller that facilitate the automated programmable control of the food distribution process (i.e., ingredient dispensing via the tubing and nozzle assembly) and mixing process.

The above-described embodiments are merely exemplary illustrations of implementations set forth for a clear understanding of the principles of the invention. Many variations, combinations, modifications or equivalents may be substituted for elements thereof without departing from the scope of the invention. Therefore, it is intended that the invention not be limited to the particular embodiments disclosed as the best mode contemplated for carrying out this invention, but that the invention will include all the embodiments falling within the scope of the appended claims.

What is claimed is:

1. A food processing system for use with a container, said system comprising:
a plurality of ingredient receptacles;
a dispenser facility configured to controllably transfer ingredients from at least one of the ingredient receptacles into the container;
a mixing facility configured to controllably mix ingredient contents within the container;
a processor configured to generate a control procedure representative of received recipe instructions; and
a controller configured to control the operation of the dispenser facility and the mixing facility according to the control procedure.

2. A food processing system according to claim 1, further comprising,
a sensor within the system and in communication with the processor for detecting the amount of ingredients to be dispensed.

3. A food processing system according to claim 1, further comprising,
a touch screen display in electrical communication with the processor for sending control signals to the processor and for displaying data.

4. A food processing system according to claim 1, further comprising,
a wireless communication connection for downloading recipes from the Internet.

5. A food processing system according to claim 3, further comprising,
Web browser software for browsing the Internet from the touch screen display for allowing users to view recipe information on the touch screen display.

6. A food processing system according to claim 1, further comprising,
a water port for connection to a water line for directing water into the container.

7. A food processing system according to claim 1, wherein the processor is programmed with one or more software routines executing on the processor and configured to:
dispense the ingredients in a metered manner.

8. A food processing system according to claim 1, wherein the processor is programmed with one or more software routines executing on the processor and configured to:
dispense the ingredients in a progressive manner during the mixing of the ingredients in the container.

9. A food processing system according to claim 1, wherein the processor is programmed with one or more software routines executing on the processor and configured to:
control the duration and intensity of the mixing of the ingredients based on the recipe instructions.

10. A food processing system according to claim 1, wherein the dispenser facility is comprised of a plurality of nozzles for controlling the dispensing of ingredients from the ingredient receptacles to the container.

11. A food processing system according to claim 1, wherein the ingredient receptacles are trays that are configured to slide in and out of the system.

12. A food processing system according to claim 11, further comprising a plurality of sifters located in each of the ingredient trays for sifting the ingredients as they are poured into the trays.

13. A food processing system for use with a container, said system comprising:
a computer processing system including a memory device, the memory device to store information, the information including recipe information;
a plurality of ingredient receptacles;
a dispenser assembly configured to controllably transfer ingredients from at least one of the ingredient receptacles into the container;
a mixing device configured to controllably mix ingredient contents within the container;
wherein the processing system is programmed with one or more software routines executing on the processing system and configured to generate a control procedure representative of received recipe instructions.

14. A food processing system according to claim 13, further comprising,
a sensor within the system and in communication with the computer processing system for detecting the amount of ingredients to be dispensed.

15. A food processing system according to claim 13, further comprising,
a touch screen display in electrical communication with the computer processing system for sending control signals to the computer processing system and for displaying data.

16. A food processing system according to claim 13, further comprising,
a water port for connection to a water line for directing water into the container.

17. A food processing system according to claim 13, wherein the computer processing system is programmed with one or more software routines executing on the computer processing system and configured to dispense the ingredients in a metered manner.

18. A food processing system according to claim 13, wherein the computer processing system is programmed with one or more software routines executing on the computer processing system and configured to dispense the ingredients in a progressive manner during the mixing of the ingredients in the container.

19. A food processing system according to claim 13, wherein the computer processing system is programmed with one or more software routines executing on the computer processing system and configured to control the duration and intensity of the mixing of the ingredients based on the recipe instructions.

20. A food processing system according to claim 13, wherein the dispenser assembly is comprised of a plurality of nozzles for controlling the dispensing of ingredients from the ingredient receptacles to the container.
